(19) United States
(12) Patent Application Publication
(10) Pub. No.: US 2009/0002422 A1
(43) Pub. Date: Jan. 1, 2009

(54) STRUCTURE FOR MONOLITHIC THERMAL INKJET ARRAY

(76) Inventor: Stanley W. Stephenson, III, Spencerport, NY (US)

Correspondence Address: David A. Novais;Patent Legal Staff, Eastman Kodak Company, 343 State Street, Rochester, NY, 14650-2201, US

(21) Appl. No.: 11/771,051

(22) Filed: Jun. 29, 2007

(51) Int. Cl. B41J 2/205; B41J 29/38

(52) U.S. Cl. 347/15; 347/12

(57) ABSTRACT

A printhead includes a plurality of nozzle arrays disposed on a substrate. Each nozzle array is positioned on the substrate to eject droplets of a liquid spaced apart from each other on a receiver. Each nozzle array is positioned relative to other nozzle arrays such that liquid ejected from the plurality of nozzle arrays is sufficient to cover a surface of the receiver in a single relative motion of the printhead and the receiver.

### CROSS REFERENCE TO RELATED APPLICATIONS

Reference is made to commonly-assigned, U.S. patent application Ser. No. 11/538,827 filed Oct. 5, 2006, entitled “ARRAY PRINTHEAD WITH THREE TERMINAL SWITCHING ELEMENTS” in the name of Stanley W. Stephenson incorporated herein by reference.

### FIELD OF THE INVENTION

This invention relates generally to the field of digitally controlled printing devices, and in particular to thermal inkjet print heads having ejectors disposed in arrays for single pass printing.

### BACKGROUND OF THE INVENTION

Ink jet printing systems apply ink to a substrate. The inks are typically dyes and/or pigments in a fluid. The ink-receiving substrate can be comprised of a material or object. Most typically, the substrate is a flexible sheet that can be a paper, polymer or a composite of either type of material. The surface of the substrate and the ink are formulated to optimize the ink lay down.

Ink drops can be applied to the substrate by modulated deflection of a stream of ink (continuous) or by selective ejection from a drop generator (drop-on-demand). The drop-on-demand (DOD) systems eject ink using either a thermal pulse delivered by a resistor or a mechanical deflection of a wall by a piezoelectric actuator. Ejection of the droplet is synchronized to motion of the substrate by a controller, which provides electrical signals to each ejector at appropriate timing to form an image.

U.S. Pat. No. 6,491,385 describes a continuous ink jet head and it's operation. A linear array of ejectors is disposed on a substrate. Each nozzle has a unique supply bore through the substrate. The supply bore ejects fluid through a nozzle in a membrane across the front surface of the supply bore. The membrane supports layers that form a pair of semi-circular resistive elements around each nozzle. Each resistor pair is pulsed to break the stream of fluid into discrete droplets. Asymmetric heating of the resistors can selectively direct the droplets into different pathways. A gutter can be used to filter out select droplets, providing a stream of selected droplets useful for printing. The modulated stream printing system requires significant additional apparatus to manage fluid flow. The droplet stream must be continually modulated.

Piezoelectric actuated heads use an electrically flexed membrane to pressurize a fluid-containing chamber. The membranes can be oriented in parallel or perpendicular to the ejection direction. U.S. Pat. No. 6,969,158 describes a piezoelectric drop-on-demand ink jet head having an electrically responsive piezo membrane perpendicular to the ejection direction that forces fluids through a nozzle. The ink jet head is formed by a stack of plates which includes the piezoelectric membrane. The piezoelectric membranes require a large amount of surface area, and multiple rows of ejectors are arrayed in depth across the head. Ejectors are arranged across the printing direction at a pitch of 50 dpi and are arrayed in the printing direction twelve ejectors deep on an angle theta to form a head having an effective pitch of 600 dpi. Such heads are complex, requiring multiple substrates that must be bonded together to form passages to the nozzle. The materials comprising the head and the structures do not lend themselves to incorporating semiconductor-switching elements.

U.S. Pat. No. 6,926,284 discloses a drop-on-demand piezoelectric inkjet head permitting single-pass printing. A single pass print head comprises 12 linear array module assemblies that are attached to a common manifold/orifice plate assembly. Droplets are ejected from the orifice by twelve staggered linear array assemblies that support piezoelectric body assemblies to provide drop-on-demand ejection of ink through the orifice array. The piezoelectric system cannot pitch nozzles closely together. In the example described, each swath module has a pitch of 50 dpi. Twelve array assemblies are necessary to provide 600 dpi resolution in a horizontally and vertically staggered fashion.

The orifice array on the plate can be a single two-dimensional array of orifices or a combination of orifices to form an array of nozzles. In the printing application, the orifices should be positioned such that the distance between orifices in adjacent lines is at last an order of magnitude (more than ten times) the pitch between print lines. The assembly is quite complex, requiring many separate array assemblies to be attached to the orifice plate thorough the use of sub frames, stiffeners, clamp bars, washers and screws. It would be advantageous to provide a staggered array in a unitary assembly with an integral orifice plate. With spacing between nozzles being less than an order of magnitude deeper than is disclosed in this patent.

U.S. Pat. No. 6,722,759 describes a common thermal drop-on-demand inkjet head structure. The drop generator consists of ink chamber, an inlet to the ink chamber, a nozzle to direct a drop exiting the chamber and a resistive element for creating an ink ejecting bubble. Linear arrays of drop generators are positioned on either side of a supply passage. Two linear arrays are fed by a common supply passage. Ink from the supply passage passes through a flow restricting ink channels to the ink chamber. A heater resistor at the bottom of the ink chamber is energized to form a bubble in the chamber and eject a drop of ink through a nozzle in the top of the chamber. A transistor is formed adjacent for each resistor to provide a three-terminal switching device to each resistor. Sets of traces are provided adjacent to the transistors to provide power, power return and switching logic to each transistor. The structure limits nozzle placement to linear rows on the sides of the ink jet supply slot.

U.S. Pat. No. 5,134,425 discloses a passive two-dimensional array of heater resistors. Voltages firing a resistor also apply partial voltages across unfired resistors. The parasitic power loss increases as the number of rows is increased to a maximum of 5 rows. Partial voltages are applied on certain lines to reduce the voltage cross talk. The partial energy does not eject a droplet, but maintains a common elevated temperature for both fired and unfired nozzles. Passive matrix arrays of resistors are limited in the depth of the array because of the parasitic resistance.

U.S. Pat. No. 6,921,156 discloses forming inkjet heads on non-silicon flat-panel substrates. Thin film transistors are coupled to an array of ink jet drop generators. The monolithic substrate is described as being made of any suitable material (preferably having a low coefficient of expansion) and discloses a ceramic substrate in the preferred embodiment. The device is multiplexed driven using flip chip devices bonded to conductors using solder. A single ink feed channel supplies two rows of nozzles. The resistors and chambers are formed using thin film processes. Multiple feedholes can supply each ejector from a single, common manifold for the two rows of ejectors. Reference to the thin film transistors on the substrate is limited, describing them as driving the resistors. The thin-film devices are formed over barrier and/or smoothing layers to isolate the thin-film devices from the substrate.

U.S. Pat. No. 5,030,971 discloses four ink jet arrays on a common heater substrate, each array disposed to receive ink from a common feed slot. Switching circuitry is disposed adjacent to each to each heater arrays, minimizing distance between adjacent feed slots. Each array ejects one of four different colors.

U.S. Pat. No. 6,932,453 discloses four sub-arrays of nozzles on a common substrate. Each nozzle array is assigned to a primitive having M drop generators. A number of primitive, N, are further organized into M possible address values. One-drop generator in a given primitive can be fired simultaneously with a drop generator in a different primitive. The primitive to address ratio is greater than 10 to 1. The electrical addressing is done in a m×n matrix, however, the drop generators are formed into arrays on either side of common ink feed slot. The close proximity of arrays on a common feed slot causes coalescence between deposited ink droplets. No mention is made as to control of droplet lay down to control coalescence.

U.S. Pat. No. 6,019,454 discloses multiple overlapping inkjet print passes with randomized dot placement to minimize coalescence. Ink is laid down in overlapping swaths. A fraction of the image is printed in each swath and successive over-printing swaths fill in unprinted areas. A variety of schemes are discussed which allocate drop placement for each successive over lying swath. The sparse array of droplets prevents coalescence, but requires the print head to make multiple passes over a given area. The multiple passes are required to prevent coalescence.

U.S. Pat. No. 6,702,425 discloses a single pass print mode. Droplets are deposited as non-contiguous droplets that spread as a function of the ink and receiver chemistry. Initially, droplets are physically spaced from each other to prevent drop coalescence. In order to fully cover the interest area of the receiver, the ink within the small, spaced droplets diffuses laterally to create a larger diameter coverage area on the media.

It would be useful for an inkjet head to fully cover a surface area of an ink receiver without coalescence between deposited droplets in a single pass of the print head and/or receiver.

### SUMMARY OF THE INVENTION

According to one aspect of the invention, a printhead includes a plurality of nozzle arrays disposed on a substrate. Each nozzle array is positioned on the substrate to eject droplets of a liquid spaced apart from each other on a receiver. Each nozzle array is positioned relative to other nozzle arrays such that liquid ejected from the plurality of nozzle arrays is sufficient to cover a surface of the receiver in a single relative motion of the printhead and the receiver.

According to another aspect of the invention, a printer includes a printhead, a receiver transport mechanism, and a controller. The printhead includes a plurality of nozzle arrays with each of the plurality of nozzle arrays including a plurality of nozzles positioned relative to each other. The receiver transport mechanism is configured to move a receiver. The controller is in electrical communication with the printhead and the receiver transport mechanism and is configured to control actuation of each nozzle of each of the plurality of nozzle arrays and relative motion of the receiver and the printhead. Liquid drops are ejected from one of the plurality of nozzle arrays and contact a receiver spaced apart from each other and are absorbed by the receiver prior to deposition of overlapping liquid drops ejected from another of the plurality of nozzle arrays. Liquid ejected from the plurality of nozzle arrays is sufficient to cover a predetermined surface area of the receiver in a single pass of the relative motion of the receiver and the printhead.

According to another aspect of the invention, a method of printing includes providing a printhead including a plurality of nozzle arrays, each of the plurality of nozzle arrays including a plurality of nozzles positioned relative to each other; providing a receiver transport mechanism configured to move a receiver; and using a controller to control actuation of each nozzle of each of the plurality of nozzle arrays and relative motion of the receiver and the printhead such that liquid drops ejected from one of the plurality of nozzle arrays contact a receiver spaced apart from each other and are absorbed by the receiver prior to deposition of overlapping liquid drops ejected from another of the plurality of nozzle arrays, wherein liquid ejected from the plurality of nozzle arrays is sufficient to cover a predetermined surface area of the receiver in a single pass of the relative motion of the receiver and the printhead.

### BRIEF DESCRIPTION OF THE DRAWINGS

In the detailed description of the example embodiments of the invention presented below, reference is made to the accompanying drawings, in which:

FIG. 1 is a top schematic view of an ejector in accordance with the present invention;

FIG. 2 is a side sectional view through the ejector shown in FIG. 1;

FIG. 3 is a top view of a prior art array of ink ejectors;

FIG. 4 is a top view of a prior art inkjet print head assembly;

FIG. 5 is a top view of an ejector in accordance with the present invention;

FIG. 6 is a side sectional view of a transistor on a substrate in accordance with the present invention;

FIG. 7 is a top schematic view of the arrangement of ejectors on an inkjet head in accordance with the present invention;

FIG. 8 is a top schematic representation of multiple ejector arrays on a common substrate in accordance with the present invention;

FIG. 9 is top view of droplets deposited by a single array in accordance with the present invention;

FIG. 10 is a top view of droplets deposited by all arrays in accordance with the present invention;

FIG. 11 is a plot of the percentage coverage verses diameter of drop as expressed in percentage of pitch;

FIG. 12 is an electrical schematic of an ink jet head in accordance with the present invention;

FIG. 13 is a schematic view of a head assembly in accordance with the present invention; and

FIG. 14 is a side view of a printer using a head in accordance with the present invention.

### DETAILED DESCRIPTION OF THE INVENTION

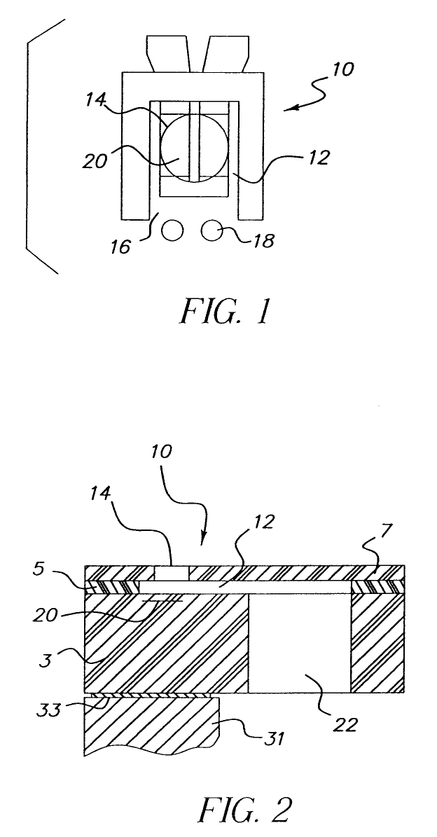

FIG. 1 is a top schematic view of an ejector 10 in accordance with the present invention. FIG. 2 is a side sectional view through the ejector shown in FIG. 1. A substrate 3 supports a polymer layer 5. Substrate 3 is most commonly a silicon wafer. In the invention, if substrate 3 is not silicon, the material can be a ceramic or a polymer. Alternatively, the substrate can be a metal such as stainless steel, nickel or alloys of the two metals, commonly known as Inconel. An ink chamber 12 is formed as a cavity in polymer layer 5 to hold a printing ink. A cover 7 over ink chamber 12 can be formed directly over polymer layer 5 using deposited ceramic, polymer or metal. Cover 7 over ink chamber 12 can also be a separate plate formed of ceramic, polymer or metal which is bonded to the polymer layer 5 defining ink chamber 12. Cover 7 has an opening to form a nozzle 14 to direct an ejected droplet of ink in a specified direction when ink chamber 12 is pressurized.

A heater resistor 20 is on the surface of substrate 3. A pulse of electrical energy to heater resistor 20 causes ink within ink chamber 12 to momentarily be converted into a gaseous state. A gas bubble is formed over heater resistor 20 within ink chamber 12, and pressurizes ink chamber 12. Pressure within ink chamber 12 acts on ink within ink chamber 12 and forces a droplet of ink to be ejected through nozzle 14. Inlet 16 supplies ink to ink chamber 12. Restriction 18 can be formed at inlet 16 to improve firing efficiency by restricting the majority of the pressure pulse to ink chamber 12. Restrictions 18 can be in the form of one or more pillars formed within inlet 16, or by a narrowing of the sidewalls in polymer layer 5 at inlet 16 of ink chamber 12.

Resistive inkjet heads are currently made using silicon for substrate 3. Heater resistor 20 and associated layers are formed over substrate 3, followed by polymer layer 5. Polymer layer 5 is patterned, followed by cover 7, which is patterned to form nozzle 14. After those layers have been formed, supply passage 22 is formed through substrate 3 using a reactive ion milling process. The reactive ion milling process has the characteristic of forming near-vertical walls through a silicon substrate 3. The ion milling process has the virtue that the process is specific to silicon and can form supply passage 22 without damage to structures associated with ejectors 10 on substrate 3. Substrate 3 is bonded to head holder 31, which has one or more cavities for supplying ink to ejectors 10 formed on substrate 3. The epoxies can be filled with silver or ceramic particles to increase thermal and electrical conductivity.

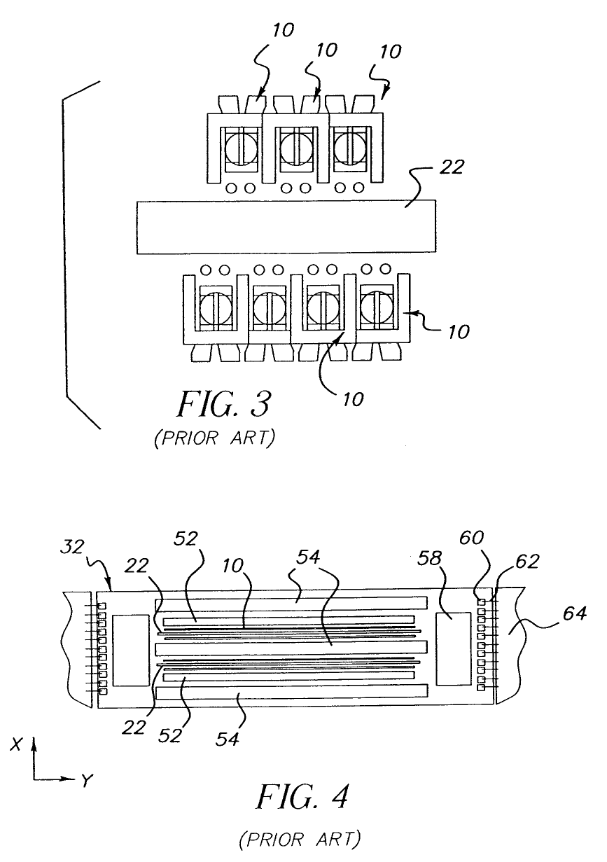

FIG. 3 is a top view of an array of prior art ink ejectors, like the ejectors described in U.S. Pat. No. 6,722,759. Ejectors 10 must be supplied by ink from the rear side of substrate 3. Ejectors 10 are arranged in two closely packed rows that share common supply passage 22. Supply passage 22 passes through substrate 3, which supplies to ink to multiple ejectors 10. Arranging two linear rows of ejectors 10 on either side of supply passage 22 provides for a compact ink jet head. Because the nozzles are adjacent to each other, fluidic cross-talk can occur between ejectors 10. Close packing of the nozzles makes the head susceptible to thermal cross talk between adjacent nozzles. Overheating can become more pronounced if substrate 3 is not silicon, but is a less thermally conductive material such as glass, ceramic, polymer or metal.

FIG. 4 is a top view of a prior art inkjet print head like the print head described in U.S. Pat. No. 6,722,759. A print head 32 has two supply passages 22, each feed slot feeding two rows of ejectors 10. A set of ejector drivers 52 is formed adjacent to each row of ejectors 10. Each ejector driver 52 is a semiconductor-switching element that is attached to each heater resistor 20 within each ejector 10. The power requirements for thermal drop on demand inkjet ejector are high, typically over 1 watt of power for approximately 1 microsecond. Ejector drivers 52 are typically formed of PMOS or NMOS transistors that are activated to selectively apply power to heater resistors 20. Alternatively, ejector drivers 52 can be formed of thin-film-transistor elements having characteristics capable of meeting the power and switching times required to thermally eject a droplet from an ejector 10.

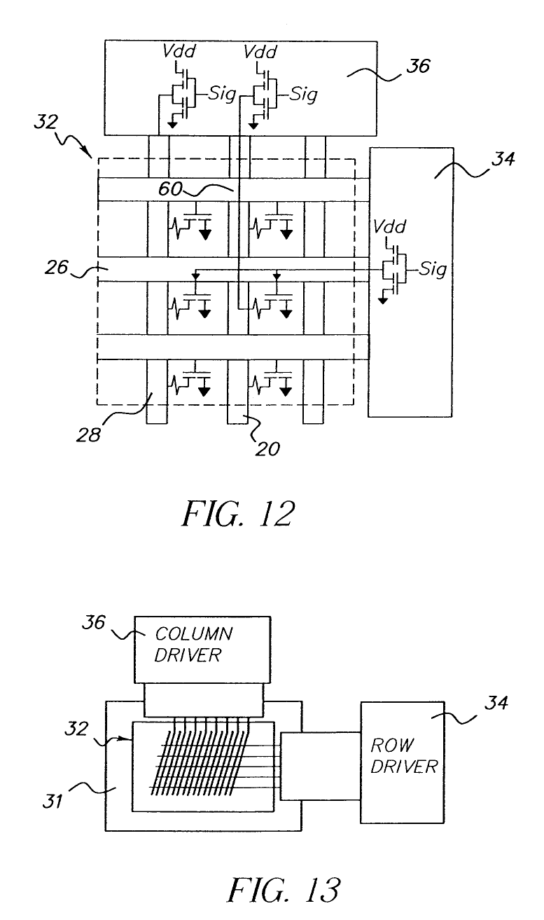

Power to ejector drivers 52 is provided by conductor lines 54 disposed on the sides and down the center of substrate 3. Conductor lines 54 supply power and control for ejector drivers 52. Control logic 58 responds to control data from printer controller 38 (shown in FIG. 12). Control logic 58 is disposed on both ends of substrate 3 to decode data signals from printer controller 38. Data and power are delivered to control logic 58 through bond pads 60. Wire bonds 62 provide connection between bond pads 60 on substrate 3 and flex circuit 64.

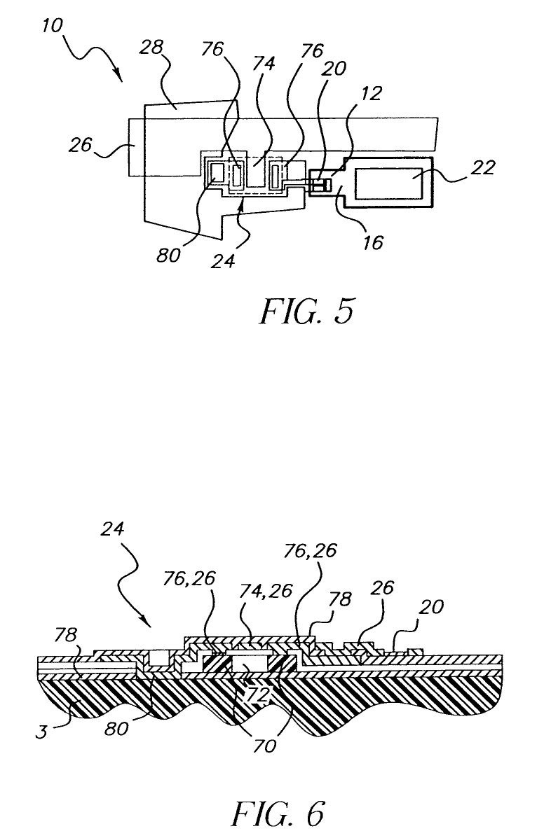

FIG. 5 is a top schematic view of an ejector in accordance with on aspect of the present invention. In the invention, an ejector 10 comprises an ink chamber 12 actuated by heater resistor 20. Ink chamber 12 is fed by inlet 16 and ejects fluid through nozzle 14 shown in FIG. 2 over resistor 20. Dedicated supply passage 22 is integral with ejector 10. If substrate 3 is made of silicon, a reactive ion etching process creates a substantially columnar supply passage 22 through substrate 3. Supply passage 22 is fed from a common cavity 29 in head holder 31 facing the back of substrate 3. Ejector 10 in accordance with the invention provides a complete assembly that can be positioned at any distance from adjacent ejectors 10 to eliminate fluidic cross talk and improve cooling efficiency. There is no common ink supply passage in substrate 3 that supplies a plurality of ejectors 10. In the case that substrate 3 is not silicon, the greater distance between ejectors 10 prevents overheating that would result from closely spaced ejectors 10 on lower conductivity substrates 3.

Referring to FIG. 5, a three-terminal device, generally referred to as a transistor 24, permits multiple ejectors 10 to be attached to a matrix of row conductors 26 and column conductors 28 and eliminates power cross talk in a matrix array of resistive elements. Row conductor 26 provides a digital logic signal to gate power supplied by column conductor 28. In this way, transistors 24 provides both power and logic multiplexing using either row conductor 26 or column conductor 28 to provide power to resistor 20 when a gating voltage is applied on the other conductor. Transistors 24 and individual supply passages 22 permit ejectors 10 to be organized on substrate 10 in large numbers of both columns and rows.

Transistor 24 can be fabricated in several ways. For example, when substrate 3 is a single crystalline semiconductor material such as silicon, transistor 24 can be included in substrate 3 by appropriately doping portions of the single crystalline semiconductor material forming substrate 3. Alternatively, transistor 24 can be arranged over substrate 3 and be formed by a plurality of thin film material layers over substrate 3.

FIG. 6 is a side sectional view of a transistor on a substrate in accordance with an embodiment of the invention. In the example, transistors 24 are thin-film transistors formed over dielectric layer 78 over substrate 3. Two doped areas 70 provide pools of charge in a semiconductor material, such as polysilicon. Channel 72 is disposed between doped areas 70 and is responsive to a field applied to gate electrode 74. The presence of a field on gate electrode 74 permits current to flow between doped areas 70. Various levels and types of n or p dopants can be applied to doped areas 70 and channel 72 to change the characteristics of transistor 24. Transistor contacts 76 are applied through dielectric 78 to supply power through transistor 24. In the invention, transistor contacts 76, for example, a first electrical contact and a second electrical contact, are formed of the material comprising row conductors 26 to minimize layers. In the case that substrate 3 is silicon, doped areas 70 and channel 72 are formed in the substrate through diffusion methods.

In the exemplary embodiment, gate electrode 74 and transistor contacts 76 are isolated areas of the material providing row conductor 26. An opening is made through dielectric layers 78 to provide substrate contact 80 between one transistor contact 76 and substrate 3. In the invention, two of the device terminals provide switching and power means, which are through gate electrode 74 and the transistor contact 76, not connected to substrate 3. The power return is through the substrate using substrate contact 80. In the embodiment, it is important that the substrate provide sufficient conductivity that the power delivered to multiple ejectors 10 be transmitted through substrate 3. In the case of very wide heads, the number of ejectors can be large, and applied power can be high, otherwise requiring thick, wide conductors 26 and 28. Returning the power through the substrate reduces the area and layers required for conductors 26 and 28.

In the case that substrate 3 is silicon, the silicon must be heavily doped with either p or n type dopants to raise the conductivity of the wafer to a high level, below 1 ohm-centimeter, and preferably below 0.01 ohm-centimeter. Either n doping or p doping, with n dopants having the greates effect on reducing substrate resistance, can form doped silicon materials having such low resistance. In the case that substrate 3 is silicon and the substrate is highly conductive, row conductors 26 and column conductors 28 are isolated from the conductive substrate by dielectric 78. The embedded transistor 24 can also be isolated from the conductive silicon substrate 3 by the use of epitaxial layers as shown on page 306 of “Microchip Manufacturing”, by Stanley Wolf, ISBN 0-9616721-8-8. Conducting power back through the substrate eliminates additional layers and components. The structure permits row conductors 26 and column conductors 28 to be thin, and ejectors 10 can be packed closely together.

Column conductors 28 are formed over dielectric layer 78 and have through via to connect conductor 26 to transistor contacts 76 to complete the circuit. The structure of the matrix electrical backplane of the invention uses two metal layers spaced from substrate 3 by dielectric layer 78 and spaced from each other by a dielectric layer 78. The structure provides a logic and power matrix inkjet array backplane with a minimal number of layers.

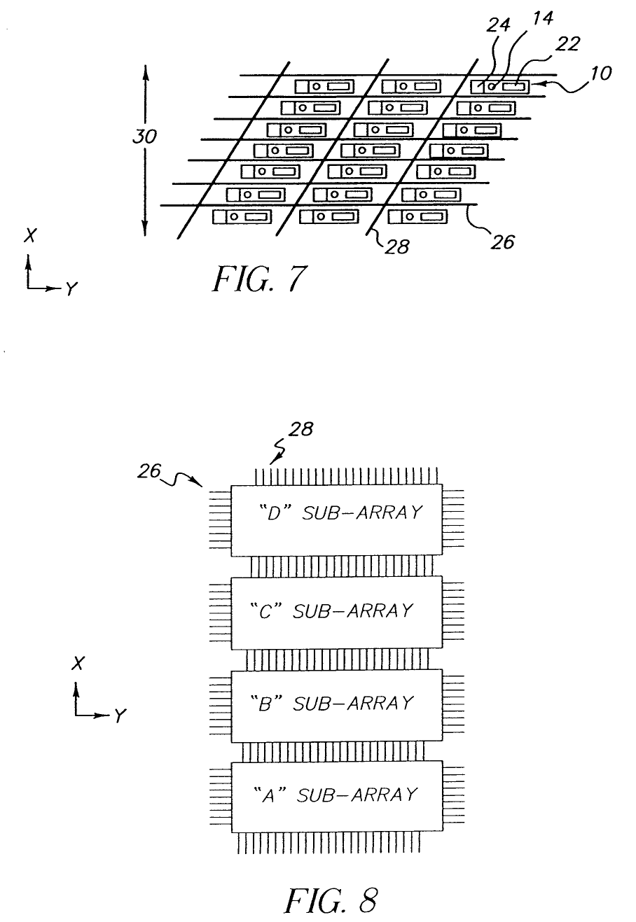

FIG. 7 is a schematic representation of an ejector array in accordance one example embodiment of the invention. A coordinate system is shown and includes a first direction X, with X an axis of motion between the printhead and an ink-receiving surface, commonly referred to as a printing direction. A second direction Y is also shown with Y being a cross printing direction. A direction Z is also shown with Z being a direction perpendicular to the printhead. This is commonly referred to as the direction of ink drop ejection from the printhead.

Ejectors 10 are shown schematically as an area having individual supply ports 22 and nozzles 14 and transistors 24. Ejectors 10 have been attached to a matrix of row conductors 26 and column conductors 28 to form laterally staggered columns of ejectors 10. Each ejector 10 of a column of ejectors is staggered at a desired pitch, typically expressed in dpi or microns, which is finer than the pitch of the ejector columns. In an example, each column can be pitched 600 microns apart due to the area required for each ejector 10. If the required printing pitch is 40 microns, each ejector in the column can be laterally staggered 40 microns to a depth of 15 ejectors (40×15=600) to achieve the required 40 micron printing pitch. The staggered matrix array can be placed on a single substrate. Transistors 24 attached to ejectors 10 using row conductors 26 as the gate lines and column conductors 28 as power supply lines permit thermal Drop-On-Demand print heads having a large number of rows along printing direction X with close packing.

The embodiment shown in FIG. 7 is particularly well suited for print heads having large area arrays, for example, print heads having a print width across the Y direction of over of 100 millimeters and a print depth dimension Y of 18 millimeters. However, the large area array print head can have other length and width dimensions. One head (or a plurality of large area array print heads stitched together) can be used to form a page wide print head. In a page wide print head, the width of the printhead is preferably at least equal to the width of the receiver and is not repeatedly passed across the page as the page advances. The width of the page wide printhead is scalable depending on the specific application contemplated and, as such, can range from less than one inch to lengths exceeding twenty inches.

The deposited fluid forms hemispherical droplets of ink on the surface of substrate 3 at a given diameter. Deposited droplets require time to evaporate or be absorbed into the substrate. For example, when the substrate is photographic paper and aqueous inks are deposited on the substrate, the droplets require 5 to 10 milliseconds to be absorbed into the substrate. If adjacent droplets are deposited and touch during the 5 to 10 millisecond absorption time, the ink droplets run together, coalescing into large irregular shapes that create defects in high quality images. It would be useful to fully cover the surface of the substrate with a high-quality image in a single pass under printhead 32 without the fluid coalescence.

FIG. 8 is a top schematic representation of multiple ejector arrays on a common substrate in accordance with an example embodiment of the invention. In this embodiment, four sub-arrays of ejectors 10 like those shown in FIG. 7 are arranged to deposit droplets at a 40-micron cross-printing pitch. Each ejector 10 is further pitched in the printing direction, Y, by 240 microns. The depth of each subarray is 3,600 microns or 3.6 millimeters and includes 15 rows of ejectors 10. Four subarrays, A, B, C and D, are formed on a common substrate and can share common column conductors 28. Subarrays A, B, C and D can be attached to 60 row conductors 26. Row conductors 60 are actuated sequentially to deposit four sets of droplets, A, B, C and D, onto substrate 3. When the ejectors are positioned on a common substrate, accurate alignment between the ejectors and their ejected droplets is possible and simplifies electrical connection and drive.

In this example embodiment, each ejector is activated for 1 microsecond, and has an additional data load time of 1 microsecond. Firing 60 rows requires 2 usec times 60 rows, or 120 microseconds. The functional firing rate of the head is 8.3 kHz. The print head is designed to deposit drops at a 40 micron pitch in the printing (X) direction. At the exemplary frequency and pitch, the print head can deposit ink on a substrate 0.3 meters (13 inches) per second. This corresponds to printing a standard 4R photographic print in less than one-half second.

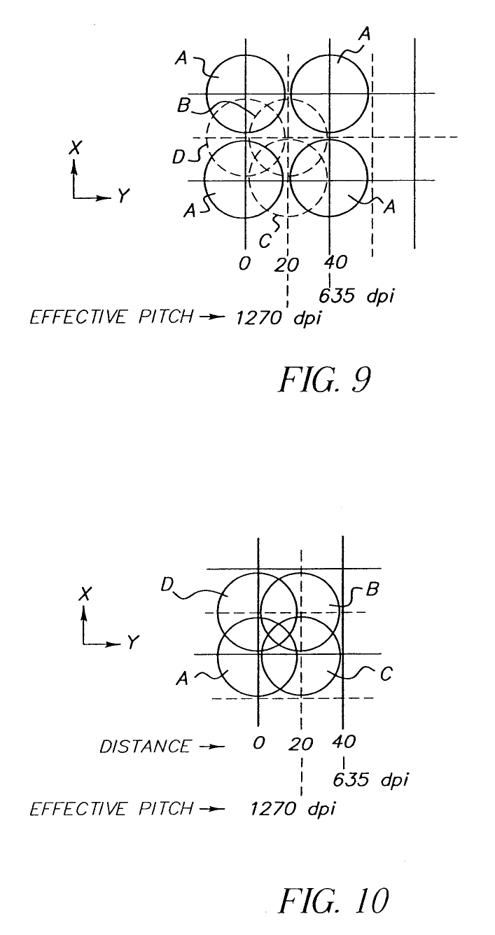

FIG. 9 is top view of droplets deposited by a single sub-array. A single sub-array deposits droplets onto the surface of substrate so that the deposited diameter of each droplet is less than the X and Y pitches. Deposited droplets form substantially round blots equally spaced relative to X and Y pitches. The droplet volume is set to create blots on the surface of substrate 3 below the 40 micron pitch, for example, 35 microns. The diameter of the droplet can be predetermined by design of the size of ink chamber 12 and the diameter of nozzle 14. In another approach, the deposited drop diameter (also referred to as a blot) is pre-selected, and the pitch of the ejectors 10 within each array is designed to space apart deposited droplets from each array by a small margin. The X direction pitch is set to the Y direction pitch, in this example 40 microns, by synchronizing the firing rate of the print head with the motion of the substrate 3 so that the pitch between droplets in printing direction X is also 40 microns.

FIG. 10 is a top view of droplets deposited by all four sub-arrays. Each sub-array is positioned to overlap the deposited droplets to cover the interest area of substrate 3 after printing by all four sub-arrays in a single pass of the print head. The position of each subarray is adjusted during design so that the subarrays are built into the head. Conventional MEMs tooling techniques precisely locate the sub-arrays on a common substrate.

The sub-arrays are offset from each other by half the pitch in the X and Y directions to effect full coverage. The diameter of the droplets must be less than the pitch, P to prevent coalescence. Full coverage of the interest area of the substrate surface requires that the droplets have a diameter greater than 0.707 P. This can be expressed as: 0.707<P<1.00. In the given example, the droplet diameter should be greater than 28.2 microns and less than 40 microns. When the deposited droplet have the minimum diameter, 0.707 P, the percentage of ink deposited provides 157% coverage (4*Pi/4*(P)), even though the blots are just touching.

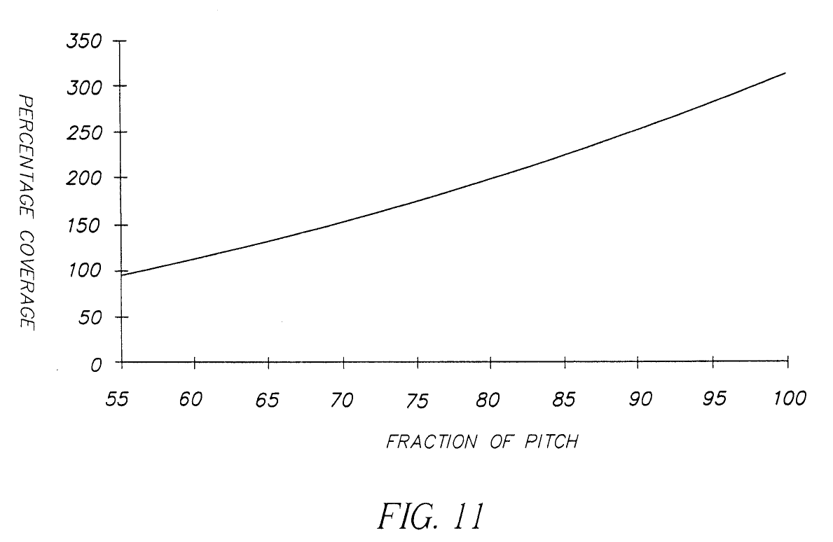

FIG. 11 is a plot of the percentage coverage verses diameter of deposited drop as expressed in a percentage of the pitch. In the example embodiment, when the deposited droplet diameter is 0.82 P or 32 microns, the deposited droplets from the sub-arrays have an effective 200% area of coverage. Using the four droplets in a single pass permits using lower density inks with over coverage(s) shown in FIG. 11. Photographic image quality is improved by using lower concentration inks that reduce image noise typically associated with prints made using high optical density inks. In general, ink density can be reduced from a target density by the reciprocal of the fractional over-coverage for a given droplet diameter. Thus, for the case of 0.82 P, 32 microns blot size, the density of the ink can be reduced by 50% to reduce noise error in photographic prints using the print head of the invention.

FIG. 12 is an electrical schematic of an ink jet head in accordance with the present invention. Print head 32 includes a plurality of drivers 34 and 36 electrically connected to the plurality of row conductors 32 and the plurality of column conductors 28. The drivers are operable to provide current to each resistive element row sequentially. In FIG. 12, each column conductor 28 is connected to a column driver 36. Column driver 36 can be, for example, an ST Microelectronics STV 7612 Plasma Display Panel Diver chip that is connected to each column conductor 28. The chip responds to digital signals to either apply a drive voltage or ground to each column conductors. Each row conductor 26 is connected to a row driver 34. Row driver 34 can be the same ST Microelectronics STV 7612 Plasma Display Panel Diver chip to provide either a gating voltage (Vdd) or ground to each row conductor 26. Transistor 24, provided with each ejector 10, responds to the logic and power states to permit print head 32 to be logically driven in a row sequential fashion without parasitic resistance effects.

Print head 32 is fired row sequentially. Digital signals apply a drive voltage (Vdd) or ground voltage to each column conductor 28. Column conductors 28 having an applied drive voltage provide energy to the ejector attached to column conductor 28 and the grounded row conductor 26. Column conductors 28 at ground voltage are not fired. Row driver 34 applies a Gate voltage (Vdd) to a row of ejectors 10 to enable firing of powered ejectors 10 of a given row, while the remaining rows remain at ground voltage regardless of power applied to their associated column conductor 28. This process is repeated to apply an image wise pattern of ink droplets from print head 32. Alternatively, a gate can be first applied to the selected row conductor 26. Data is loaded into column drivers 36 and then an enable line is activated on column driver chip 36 to selectively apply power to ejectors 10 on the selected row.

Only a single ejector 10 on any given column conductor 28 is active at any one time, which permits column conductor 28 to be thin because they never carry more than the current of one ejector 10. However, all ejectors 10 on the selected row conductor 26 can be fired, which represents a large amount of current and power that is returned through substrate 3. In a 110-millimeter head having 183 activated heater resistors 20 on a line, each sinking 50 mille-amperes, 9.1 amps will pass through substrate 3. Alternatively, subsets of ejectors 10 one a single row conductor 32 can be energized to reduce power return through substrate 3.

FIG. 13 is a schematic view of a head assembly in accordance with the present invention. Print head 32 has been mounted to head holder 31, which holds a supply of ink in a cavity 29 behind substrate 3 to supply ink through substrate 3 to ejectors 10 mounted on the front of substrate 3. Row driver 34 and column driver 36 are attached to head holder 31 and wire bonds are made between the flex circuit for the drivers to the row and column conductors on print head 32. The width of the head is not limited to a single column driver 36. The width can be extended and additional column drivers 36 added to provide power to additional columns.

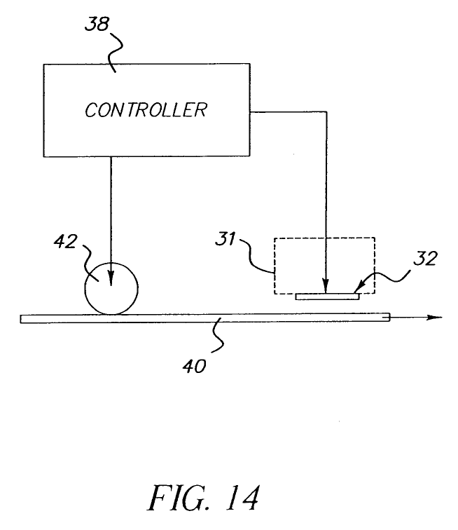

FIG. 14 is a schematic side view of a printer using a head in accordance with the present invention. Controller 38 moves an ink receiver 40 using receiver driver 42. Receiver driver 42 is a motor that operates on a plate or roller to drive ink receiver 40 under print head 32. Controller 38 provides drive signals to row driver 34 and column driver 36 connected to print head 32 to apply an image-wise pattern of ink droplets onto ink receiver 40 in synchronization with the motion of ink receiver 40.

Controller 38 is programmed to detect the position of ink receiver 40 as it is moved under print head 32. The motion of ink receiver 40 can be broken into a set of sequential positions that correspond to a matrix of binary image data, with each position in the matrix corresponding to ink deposition or ink not-deposition. For each position of ink receiver 40 moves into under the control of controller 38, appropriate ejectors 10 are discharged to deposit blots on corresponding to the image data. Print head 32 ejects droplets by firing each row sequentially until all ejectors 10 have fired a single ejection sequence. The blots deposited on the paper are patterned across ink receiver 40 based on the physical positioning of ejectors 10 relative to each other. The fixed geometric positioning of the nozzles permits data to be selected from an image file based on the predetermined position of each ejector 10. After each ejection sequence, ink receiver 40 has moved to the next position and receives another set of blots. The printing process continues sequentially until a full image has been deposited on ink receiver 40. Controller 38 can be used to adjust either actuation of each nozzle of each of the of nozzle arrays, the relative motion of the receiver and the printhead, or both in order to accommodate different receiver and liquid combinations.

The invention has been described in detail with particular reference to certain preferred embodiments thereof, but it will be understood that variations and modifications can be effected within the scope of the invention.

### PARTS LIST

3 substrate
5 polymer layer
7 cover
10 ejector
12 ink chamber
14 nozzle
16 inlet
18 restriction
20 heater resistor
22 supply passage
24 transistor
26 row conductor
28 column conductor
29 cavity
30 spacing distance
31 head holder
32 print head
33 conductive adhesive
34 row drivers
36 column drivers
38 printer controller
40 ink receiver
42 receiver driver
52 ejector drivers
54 conductor lines
58 control logic
60 bond pads
62 wire bonds
64 flex circuit
70 doped areas
72 channel
74 gate electrode
76 transistor contacts
78 dielectric layer
80 substrate contact

What is claimed is:

1. A printer comprising:
a printhead including a plurality of nozzle arrays, each of the plurality of nozzle arrays including a plurality of nozzles positioned relative to each other;
a receiver transport mechanism configured to move a receiver; and
a controller in electrical communication with the printhead and the receiver transport mechanism, the controller being configured to control actuation of each nozzle of each of the plurality of nozzle arrays and relative motion of the receiver and the printhead such that liquid drops ejected from one of the plurality of nozzle arrays contact a receiver spaced apart from each other and are absorbed by the receiver prior to deposition of overlapping liquid drops ejected from another of the plurality of nozzle arrays, wherein liquid ejected from the plurality of nozzle arrays is sufficient to cover a predetermined surface area of the receiver in a single pass of the relative motion of the receiver and the printhead.

2. The printer of claim 1, wherein the plurality of nozzle arrays are positioned on a common substrate.

3. The printer of claim 1, wherein the plurality of nozzle arrays are positioned on multiple substrates.

4. The printer of claim 1, wherein the nozzles of each of the plurality of nozzle arrays have a pitch P and the liquid drops have a deposited diameter that is less than P.

5. The printer of claim 1, wherein the controller is configured to adjust at least one of actuation of each nozzle of each of the plurality of nozzle arrays and relative motion of the receiver and the printhead to accommodate different receiver and liquid combinations.

6. The printer of claim 1, wherein the nozzles of each of the plurality of nozzle arrays have a pitch P the liquid drops have a deposited diameter that is less than P and greater than 0.707 P.

7. The printer of claim 1, the liquid including a ink concentration having a target density, wherein the ink concentration is less than the target density.

8. A method of printing comprising:
providing a printhead including a plurality of nozzle arrays, each of the plurality of nozzle arrays including a plurality of nozzles positioned relative to each other;
providing a receiver transport mechanism configured to move a receiver; and
using a controller to control actuation of each nozzle of each of the plurality of nozzle arrays and relative motion of the receiver and the printhead such that liquid drops ejected from one of the plurality of nozzle arrays contact a receiver spaced apart from each other and are absorbed by the receiver prior to deposition of overlapping liquid drops ejected from another of the plurality of nozzle arrays, wherein liquid ejected from the plurality of nozzle arrays is sufficient to cover a predetermined surface area of the receiver in a single pass of the relative motion of the receiver and the printhead.

9. A printhead comprising:
a plurality of nozzle arrays disposed on a substrate, each nozzle array positioned on the substrate to eject droplets of a liquid spaced apart from each other on a receiver, each nozzle array being positioned relative to other nozzle arrays such that liquid ejected from the plurality of nozzle arrays is sufficient to cover a surface of the receiver in a single relative motion of the printhead and the receiver.

10. The printer of claim 9, wherein the nozzles of each of the plurality of nozzle arrays have a pitch P and the liquid drops have a deposited diameter that is less than P.

11. The printer of claim 9, wherein the plurality of nozzle arrays are positioned on the same substrate.

12. The printer of claim 9, the substrate including a plurality of substrates, wherein each of the plurality of nozzle arrays are positioned on a corresponding one of the plurality of substrates.

13. The printer of claim 9, further comprising:
a controller configured to adjust actuation of each nozzle of each of the plurality of nozzle arrays of the printhead.

14. The printer of claim 9, wherein the nozzles of each of the plurality of nozzle arrays have a pitch P the liquid drops have a deposited diameter that is less than P and greater than 0.707 P.

15. The printer of claim 9, the liquid including a ink concentration having a target density, wherein the ink concentration is less than the target density.
